(19) United States
(12) Patent Application Publication
(10) Pub. No.: US 2009/0261983 A1
(43) Pub. Date: Oct. 22, 2009

(54) MULTIFUNCTIONAL PORTABLE ELECTRONIC DEVICE

(75) Inventor: XIAO-KUN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/190,671

(22) Filed: Aug. 13, 2008

(30) Foreign Application Priority Data
Apr. 18, 2008 (CN) 200810301205.8

(51) Int. Cl. G08B 21/00

(52) U.S. Cl. 340/686.1

(57) ABSTRACT

The invention discloses a multifunctional portable electronic device (100) which includes a sound detecting module (10) and a warning module (30). The sound detecting module (10) is electrically connected within the multifunction portable electronic device (100) to induce the outside voice signal. The warning module (30) includes an irradiance module (31) electrically connected with the sound detecting module (10). When the sound detecting module (10) receives a voice signal, it will drive the warning module (30) to make the irradiance module (31) irradiate dazzling light.

### BACKGROUND

1. Technical field

The present invention generally relates to a multifunctional portable electronic device, particularly to a multifunctional portable electronic device with a sound control positioning function.

2. Discussion of the Related Art

With the development of wireless communication and information processing technology, portable electronic devices such as mobile phones and personal digital assistants (PDAs) are now in widespread use. Consumers may now enjoy the full convenience of high technology products almost anytime and anywhere.

Because of the small size of the portable electronic device, when users misplace or drop the portable electronic device in a dark environment, it may be difficult to locate or find the portable electronic device. Losing a portable electronic device can greatly inconvenience its owner.

Therefore, there is room for improvement within in the art.

### BRIEF DESCRIPTION OF THE DRAWING

Many aspects of the present multifunctional portable electronic device can be better understood with reference to the following drawing. The components in the drawings are not necessarily drawn to scale, the emphasis instead being placed upon clearly illustrating the principles of the present multifunctional portable electronic device.

The drawing shows a block diagram of a multifunctional portable electronic device, in accordance with an exemplary embodiment of the present invention.

### DETAILED DESCRIPTION OF THE EMBODIMENT

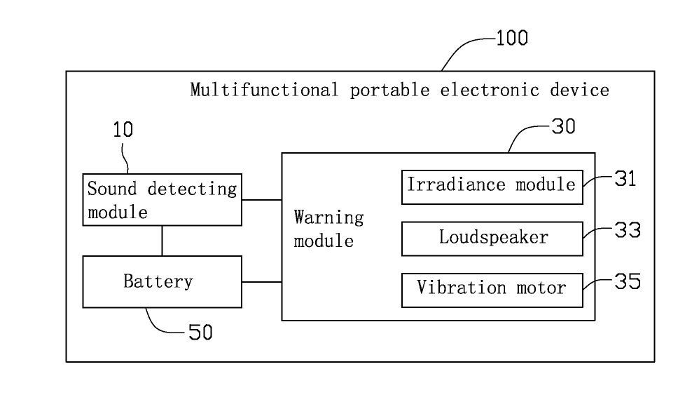

Referring to the drawings in detail, FIG. 1 shows a block diagram of a multifunctional portable electronic device 100 according to an exemplary embodiment of the present invention. The multifunctional portable electronic device 100 can be a mobile phone, personal digital assistant (PDA), etc. The multifunctional portable electronic device 100 includes a sound detecting module 10, a warning module 30 and a battery 50. The sound detecting module 10 can be a sound detecting chip assembled within the multifunctional portable electronic device 100. The sound detecting module 10 to detect a sound, such as a voice signal a predetermined number of decibels above the ambient sound levels. The warning module 30 includes an irradiance module 31, a loudspeaker 33 and a vibration motor 35 electrically connected with the sound detecting module 10 and controlled by the sound detecting module 10 to make warning. The irradiance module 31 can be a light-emitting diode (LED). A battery 50 is electrically connected with and supplies power to the sound detecting module 10 and the warning module 30.

When using the multifunctional portable electronic device 100, if the multifunctional portable electronic device 100 is misplaced in a dark environment, the consumers can locate the multifunctional portable electronic 100 by, for example, speaking at a predetermined number of decibels above with ambient. The sound detecting module 10 assembled within the multifunctional portable electronic device 100 will detect the voice signal and signal the irradiance module 31 to emit a dazzling light, drive the loudspeaker 33 to make a sound, and/or cause the vibration motor 35 to make the personal electronic device 100 vibrate.

Battery 50 can be a detachable battery or an additional extra inner battery for supplying power to the sound detecting module 10 and the warning module 30 independently. Therefore, the sound detecting module 10 and the warning module 30 can work even though the multifunctional electronic device 100 is turned off.

The sound detecting module 10 could be set as to only detect special sounds, voice signals, or language made by the consumers, to assure the owner of the multifunctional electronic device 100 avoids accidental operation of the waning device 30.

Finally, it is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A multifunctional portable electronic device comprising:
a sound detecting module configured for detecting sound signals; and
a warning module electrically connected with the sound detecting module, comprising an irradiance module driven by the sound detecting module, to emit light when the sound detecting module detects sound signals.

2. The multifunctional portable electronic device as claimed in claim 1 further comprising a battery, the battery electrically connected with the sound detecting module and the warning module to supply power to the sound detecting module and the warning module.

3. The multifunctional portable electronic device as claimed in claim 2, wherein the sound detecting module could be a sound detecting chip which is used to detect a voice signal a predetermined number of decibels above the ambient environment.

4. The multifunctional portable electronic device as claimed in claim 3, wherein the battery can supply power to the sound detecting module and the warning module independently, to assure that sound detecting module and the warning module can work even though the multifunctional electronic device is turned off.

5. The multifunctional portable electronic device as claimed in claim 1, wherein the sound detecting module could be set to only detect special sounds, voice signals, or language made by the consumers, to avoid accidental operation of the waning device.

6. The multifunctional portable electronic device as claimed in claim 1, wherein the warning module further comprising a loudspeaker electrically connected with the battery and controlled by the sound detecting module to make warning voice.

7. The multifunctional portable electronic device as claimed in claim 6, wherein the warning module further comprising a vibration motor electrically connected with the battery and controlled by the sound detecting module to cause vibrations.

8. The multifunctional portable electronic device as claimed in claim 1, wherein the irradiance module is a light-emitting diode.

9. The multifunctional portable electronic device as claimed in claim 1, wherein the multifunctional portable electronic device is a mobile phone or a personal digital assistant.
